(19) United States
(12) Patent Application Publication
(10) Pub. No.: US 2010/0084848 A1
(43) Pub. Date: Apr. 8, 2010

(54) FOLDABLE CLIPBOARD

(76) Inventor: Andrew Nguyen, La Habra, CA (US)

Correspondence Address: BUUS, KIM, KUO, & TRAN, APC, 4675 MacArthur Court, Suite 590, Newport Beach, CA, 92660, US

(21) Appl. No.: 12/247,588

(22) Filed: Oct. 8, 2008

(51) Int. Cl. B42D 3/00; B42F 1/00

(52) U.S. Cl. 281/49; 281/45; 24/67 R

(57) ABSTRACT

The present invention is a foldable clipboard that generally comprises a flat board with an upper end and a lower end. Each flat board includes a writing surface and a rear surface. The foldable clipboard further includes an engagement means that engages the flat boards and an attachment means proximate the upper end of the writing surface. The plurality of folding serrations allows the clipboard to be in open and closed positions and provides a continuous and smooth writing surface when in an open position. The foldable clipboard protects the paper by providing an external cover in the closed position. The clipboard may include locking means to prevent unwanted movement and ensure a flat writing surface in an open position.

### BACKGROUND OF THE INVENTION

(1) Field of the Invention

The field of the invention relates to clipboards, and more particularly to a foldable and compact clipboard that can be carried in a pocket.

(2) Description of Related Art

Clipboards have been an essential mobile writing platform that provides a flat surface for writing or drawing and which incorporate a clip device to secure a sheet of papers. Clipboards with varying sizes and shapes are available commercially. Existing clipboards are cumbersome to carry due to their relatively large size and are inconvenient to operate. These clipboards have been restricted to merely carrying a few papers and sometimes cause tearing of papers. These problems cause difficulty for people who travel from one location to other, research scholars and the like.

Clipboards of various dimensions have been known for many years. U.S. Pat. No. 403,233 to Weagly on May 14, 1889, discloses a folding clipboard. The base consists of narrow rectangular wooden slats connected to each other and top slats by means of a sheet of canvas. The sheet of canvas is gummed to the upper support. This wooden slat is bulky to carry. As the canvas is gummed to the upper support when the sticky nature expires this foldable clipboard becomes useless. Moreover, the clipboard having a wooden hard surface to hold paper causes creasing of the paper.

U.S. Pat. No. 3,048,424 to Mitchell on Aug. 7, 1962, relates to a foldable clipboard having a carrier device attached for carrying paper. A sheath of flexible material is slidably engaged over the clipboard for holding paper. This arrangement is inconvenient to operate and restricted merely for carrying a few papers. Further, the clipboard features no arrangement to protect the paper from creasing.

Similarly, U.S. Pat. No. 5,324,076 to Nieradka on Jun. 28, 1994, teaches a portable clipboard with a latching pull out drawer. The sliding drawer extension increases the length of the overall clipboard. The clipboard requires an enormous amount of space for mounting over a surface. Additionally, the writing surface is not suitable for smooth writing due to the pull out drawer and the whole apparatus is bulky.

U.S. Pat. No. 5,887,902 to Irwin on Mar. 30, 1999, discloses a traditional clipboard apparatus having a single sheet of plastic folded over to form two planar surfaces. The paper is inserted into the sandwiched area formed between the plastic sheets. The clipboard apparatus have one folded end and multiple open ends for inserting the paper. The paper is inserted through the open end and there is no protective mechanism to protect the paper from the surrounding adverse elements.

U.S. Pat. No. 4,896,927 to Liu on Jan. 30, 1990 and U.S. Pat. No. 6,637,774 to Gaska on Oct. 28, 2003, provides a clipboard with compartments for accessing paper. The writing board must be pivoted out of the way to access paper. Any paper resting upon the board must be removed or secured in place each time the user wishes to access the paper. Thus user's work is interrupted when the writing surface is lifted or pivoted.

In order to avoid the above problems, U.S. Pat. No. 20070187565 to Liptan on Aug. 16, 2007, discloses a foldable clipboard having a pair of support panels that are hinged together. The hinge mechanism can include one or more separate pieces of a pin or a gasket or other similar mechanism that are mounted to the panels. The hinge may create a bulge or other obstruction when the clipboard is in the flat configuration for writing or drawing. A hinge made of heavy material is not suited for applications like the clipboards being carried in a doctor's pocket. Moreover, the hinge causes creasing of paper which affects the smooth writing. While many of the prior art designs provide a writing surface, each of these clipboard is limited since it is designed to perform the function for which it was specifically designed. Furthermore, most of these traditional clipboards are large, bulky and not compact to carry in a pocket.

All referenced patents, applications and literatures are incorporated herein by reference to their entirety. Furthermore, where a definition or use of a term in a reference, which is incorporated by reference herein, is inconsistent or contrary to the definition of that term provided herein, the definition of that term provided herein applies and the definition of the term in the reference does not apply. The invention may seek to satisfy one or more of the above-mentioned desire. Although the present invention may obviate one or more of the above-mentioned desires, it should be understood that some aspects of the invention might not necessarily obviate them.

In these respects, the foldable clipboard according to the present invention substantially departs from the conventional concepts and designs of the prior art, and so doing provides a foldable clipboard device that is not anticipated, rendered obvious, suggested or even implied by any of the prior art foldable clipboard, either alone or in combination thereof.

### BRIEF SUMMARY OF THE INVENTION

In view of the foregoing disadvantages inherent in the known types of foldable clipboard and means now present in the prior art, the general purpose of the present invention, which will be described subsequently in greater detail, is to provide a foldable clipboard which is compact and portable depending upon the use.

Another object of the present invention is to provide a foldable clipboard, which can be folded or unfolded depending on the use by a plurality of folding serrations;

Another object of the present invention is to provide a foldable clipboard, which in a folded state protects the paper rendering an external cover;

Another object of the present invention is to provide a foldable clipboard, which constitutes a flat writing surface in an unfolded state;

Another object of the present invention is to provide a foldable clipboard, which supports a locking latch or slidable bracket to prevent unwanted folding;

Another object of the present invention is to provide a foldable clipboard, which supports adjustable magnets to prevent unwanted folding;

Another object of the present invention is to provide a foldable clipboard, which is inexpensive to manufacture and made of light weight material;

Another object of the present invention is to provide a foldable clipboard that said folding serrations are continuous and smooth to allow a seamless writing surface when the clipboard is at an open position.

To attain this, the present invention in one embodiment generally comprises of a foldable clipboard having a flat board with upper and lower ends, said flat board includes a writing surface and a rear surface. In one embodiment, the foldable clipboard includes an engagement means, an attachment means, and a plurality of rivets, a horizontal lip and a corresponding receiving groove.

In typical use, a plurality of folding serrations of the foldable clipboard allow the flat board to be in folded and unfolded positions. In the folded position, the foldable clipboard is firmly fixed when the horizontal lip is received by the corresponding receiving groove thereby protecting the paper rendering an external cover. The folding serrations are disengaged in an unfolded state constituting a flat writing surface. The clip allows at least one item to be held securely to the writing surface. In the present invention, the term “folding serrations” is meant to encompass all types of possible folding possibilities that also include various hinges and joints connections.

The foldable clipboard can be locked by means of a latch or slidable brackets. One end of the latch is fixed to a latch pivot rivet and another end is selectively adapted to receive a latch receiver rivet. The latch locks the clipboard by selectively engaging the latch receiver rivet. The pair of slidable brackets selectively locks and unlocks the clipboard to prevent unwanted folding of the flat boards. Alternatively, the present invention can incorporate another latch which can be used to hold the clipboard in a closed position. It is to be noted that the latch as described, is capable of being located on the front or back of the present invention. It should be also noted that other means for locking the clipboard in an open position are possible and serve the same purpose as the latch and rivet locking means. For example, adjustable magnets can be used as a locking means to prevent the plurality of serrations from unwanted movement.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting. To accomplish the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWING(S)

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a front elevational view of a foldable clipboard in accordance with the present invention;

FIG. 2 is a rear elevational view of a foldable clipboard with a latch;

FIG. 3 is a front perspective view of a foldable clipboard;

FIG. 4 is a rear perspective view of a foldable clipboard with a latch;

FIG. 5 is a front perspective view of a foldable clipboard in a partially folded position;

FIG. 6 is a perspective view of a foldable clipboard in a folded position;

FIG. 7 is a front elevational view of a foldable clipboard with locking brackets;

FIG. 8 is a rear elevational view of a foldable clipboard with locking brackets and sliding grooves;

FIG. 9 is a front perspective view of a foldable clipboard with locking brackets;

FIG. 10 is a rear perspective view of a foldable clipboard with locking brackets and sliding grooves;

FIG. 11 is a front perspective view of a foldable clipboard in a partially folded position with locking brackets; and

FIG. 12 is a perspective view of a foldable clipboard in a folded position with locking brackets and sliding grooves.

FIG. 13 is a perspective view of a foldable clipboard depicting a secondary locking latch mechanism;

FIG. 14 is a perspective view of a foldable clipboard being held in a closed position by a secondary locking latch.

FIG. 15 is a perspective view of one embodiment of the locking means of the foldable clipboard consisting of magnets

### DETAILED DESCRIPTION OF THE INVENTION

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claims are set forth below in a certain combination, it must be expressly understood that the invention includes other combinations of fewer, more or different elements, which are disclosed herein even when not initially claimed in such combinations.

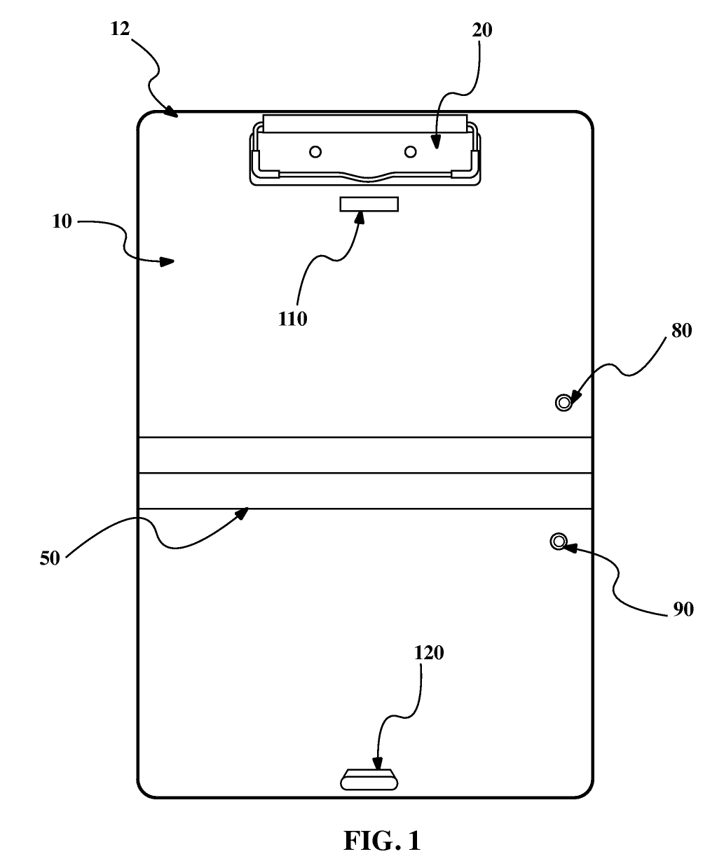

Referring now to the drawings, which are provided by way of illustration and example, and wherein like reference numerals designate like or corresponding elements among the several views, there is shown in FIG. 1, a foldable clipboard 10 having a flat board with an upper end 12 and a lower end 14. The flat board includes a writing surface and a rear surface. Alternatively, the foldable clipboard 10 may comprise of a plurality of flat boards which when combined comprise one flat board. The foldable clipboard 10 further includes an engagement means 50 that engages the flat board, an attachment means 20 proximate the upper end of the writing surface, a plurality of rivets 80 and 90 on the flat board, a horizontal lip 120 and a corresponding receiving groove 110 for receiving the horizontal lip 120. The attachment means 22 includes a clip 20 for holding at least one item (not shown) securely within the flat board. The clip 20 allows the item (not shown) to be held securely on the writing surface. The engagement means 52 engaging the flat board is a plurality of folding serrations. The plurality of folding serrations 50 prevents the item (not shown) from creasing and thereby protects the item (not shown). A locking means is provided to lock the clipboard in an open position to prevent unwanted movement of the clipboard which may affect the writing surface of the clipboard. In the present embodiment of the invention, the locking means is provided by a plurality of rivets 80 and 90 include a latch pivot rivet 80 and a latch receiver rivet 90. It should be noted that other means for locking the clipboard in an open position is possible and may be possible and serve the same purpose as the latch and rivet locking means. For example, adjustable magnets can be used as a locking means to prevent the plurality of serrations from unwanted movement. The horizontal lip 120 is proximate the lower end 14 of the writing surface and the corresponding receiving groove 110 is upper end 12 of the writing surface. When connected, the horizontal lip 120 and receiving groove 110 act as a securing mechanism to keep the foldable clipboard 10 in a closed position.

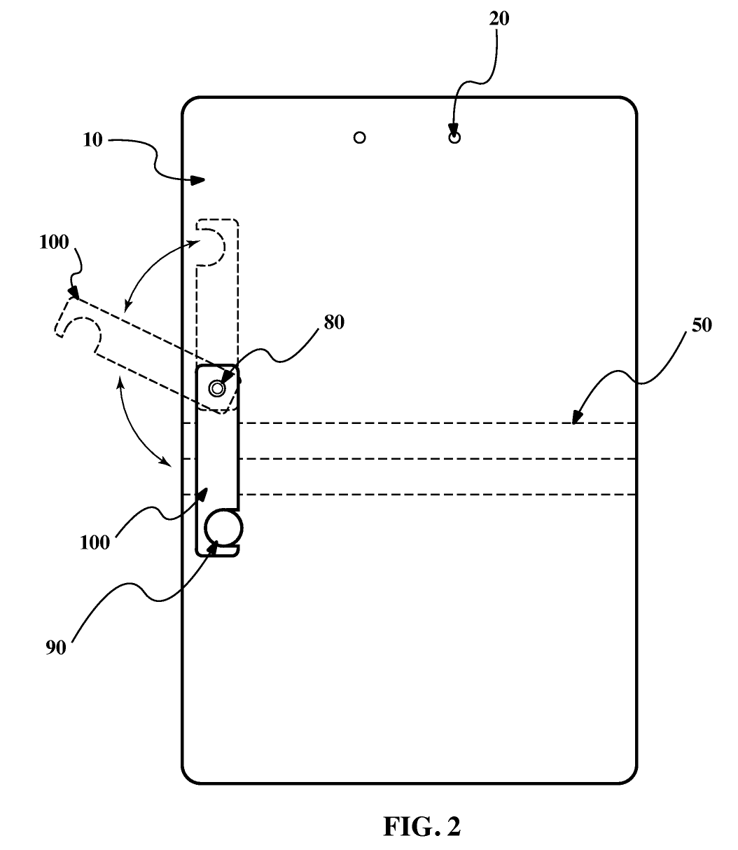

Turning now to the embodiment of FIG. 2, the foldable clipboard 10 can be locked by means of at least one latch 100. One end of the latch 100 is fixed to the latch pivot rivet 80 and another end is selectively adapted top receive a latch receiver rivet 90. The latch 100 locks the clipboard 10 by selectively engaging the latch receiver rivet 90. The latch 100 unlocks the clipboard 10 by selectively disengaging the latch receiver rivet 90. The latch 100 is affixed to the rear side of the clipboard 10 thereby protecting the item (not shown).

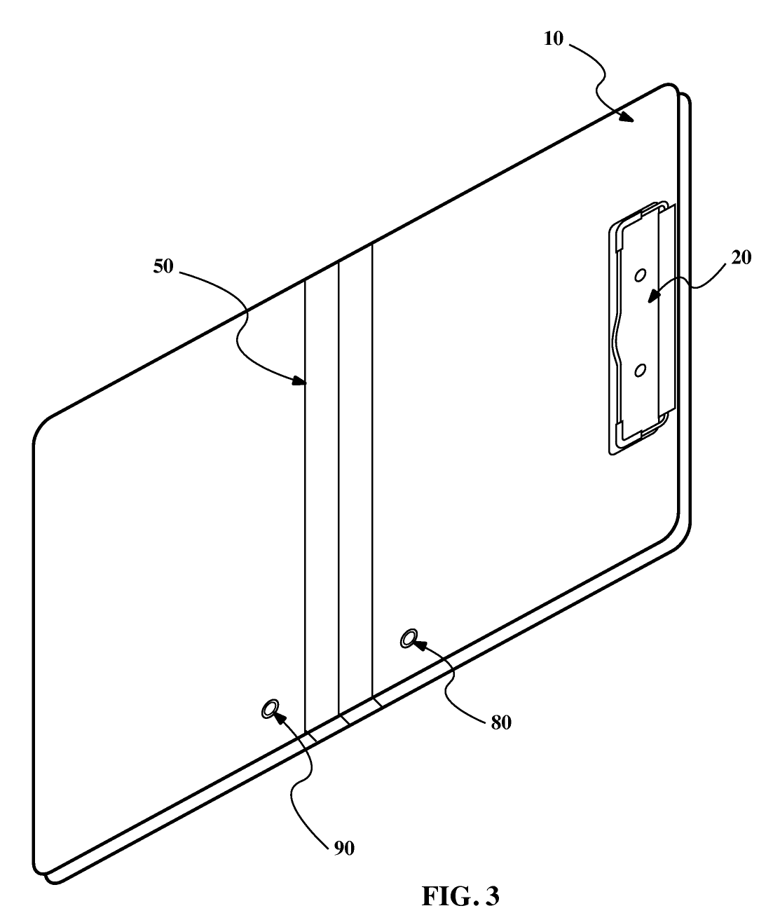

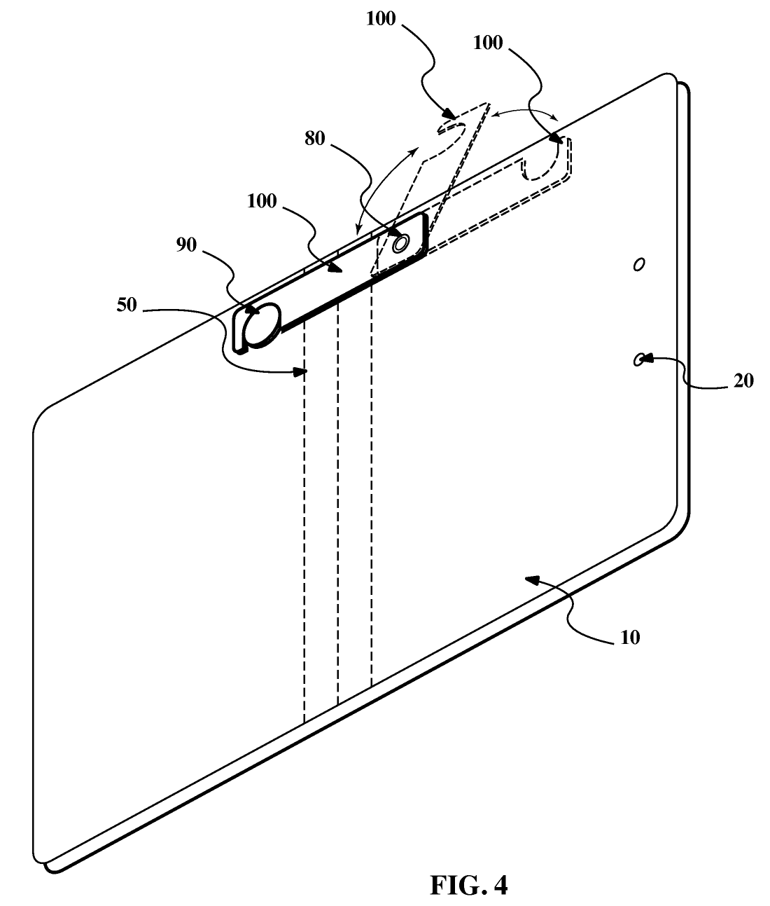

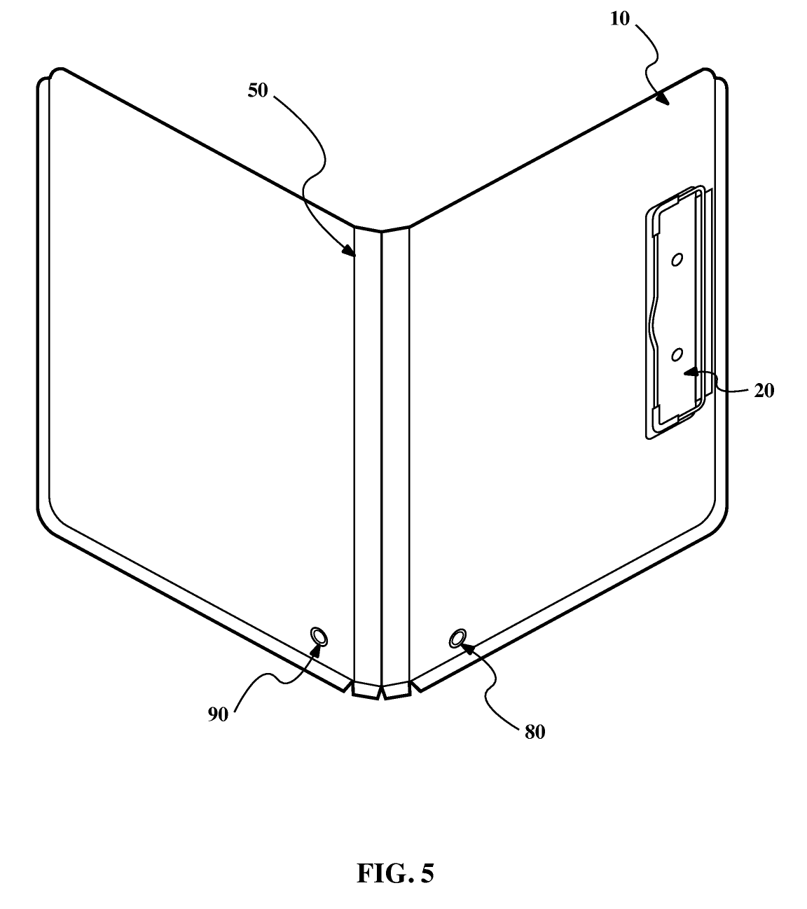

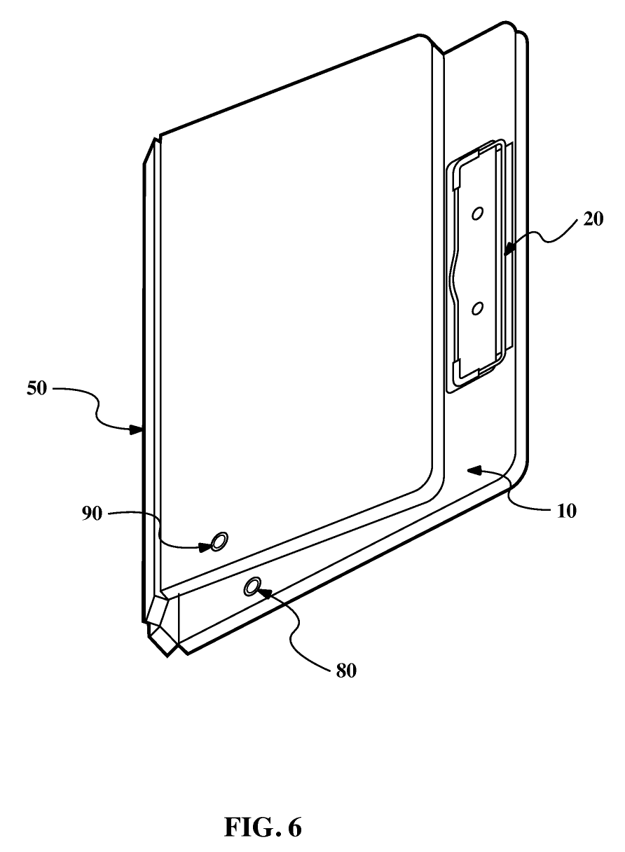

FIG. 3 shows a front perspective view of the foldable clipboard 10. FIG. 4 shows a rear perspective view of the foldable clipboard 10 in the unfolded position. As shown in FIG. 5, the foldable clipboard 10 can be partially folded and FIG. 6 shows the perspective view of the foldable clipboard 10 in folded position. The plurality folding serrations 50 of the foldable clipboard 10 allow the flat board to be in folded and unfolded positions. The plurality of folding serrations 50 prevent the item (not shown) from creasing. The foldable clipboard 10 protects the item (not shown) by providing an external cover in the folded position. In the folded position the foldable clipboard 10 is firmly fixed when the horizontal lip 120 is received by the corresponding receiving groove 110. The plurality of folding serrations 50 is disengaged in an unfolded state for providing a flat writing surface.

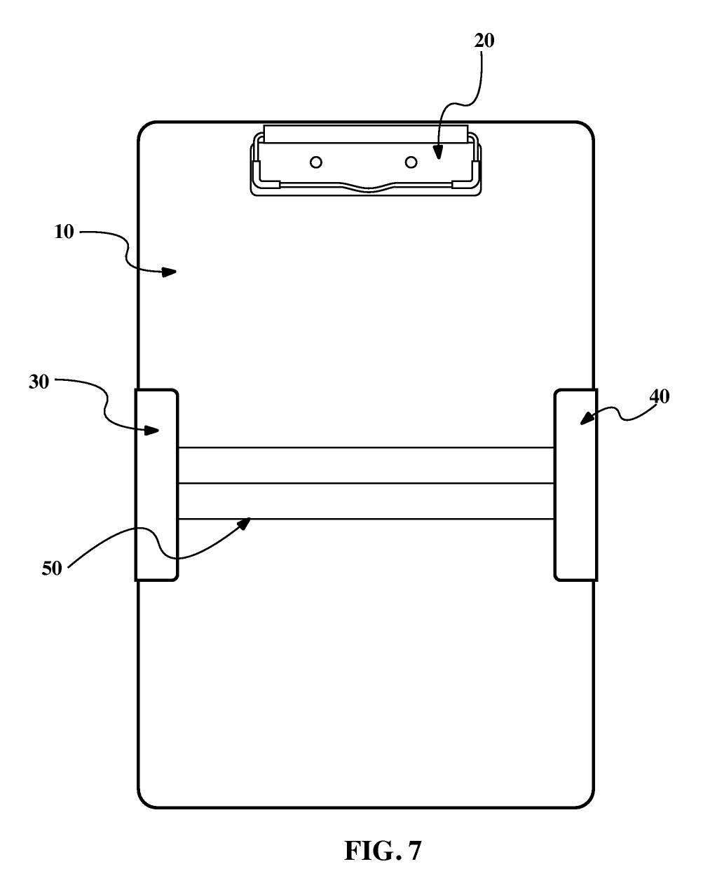

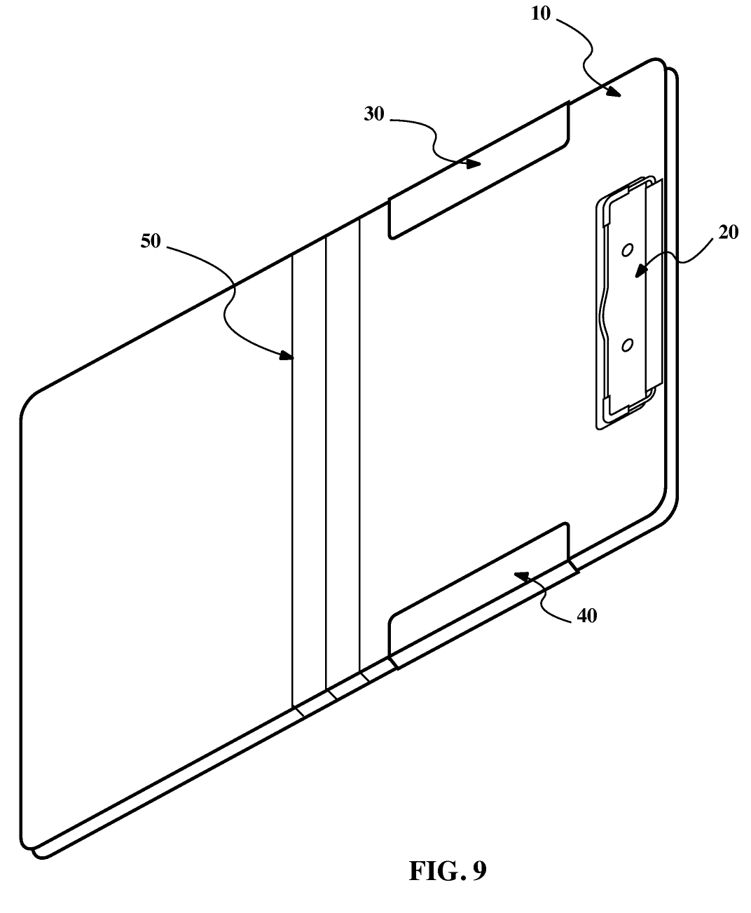

FIG. 7 illustrates the foldable clipboard 10 with at least one pair of slidable brackets 30 and 40 in locking position and FIG. 9 illustrates the foldable clipboard 10 with at least one pair of slidable brackets 30 and 40 in unlocking position. The pair of slidable brackets 30 and 40 is located at the opposing ends of the flat boards. The pair of slidable brackets selectively locks and unlocks the clipboard 10 in place to prevent unwanted folding of the flat boards. The pair of slidable brackets includes a left locking bracket 30 and a right locking bracket 40.

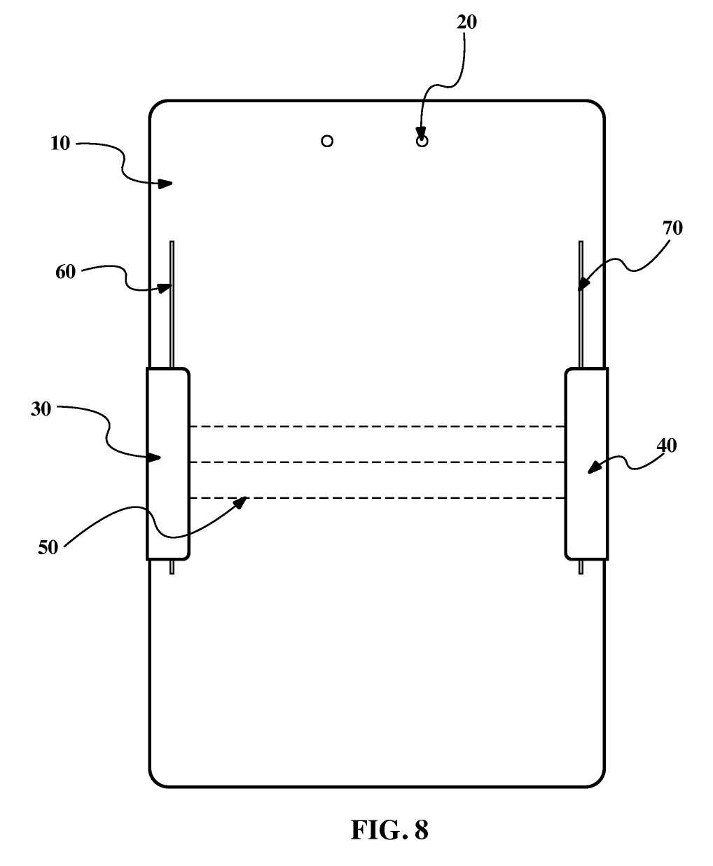

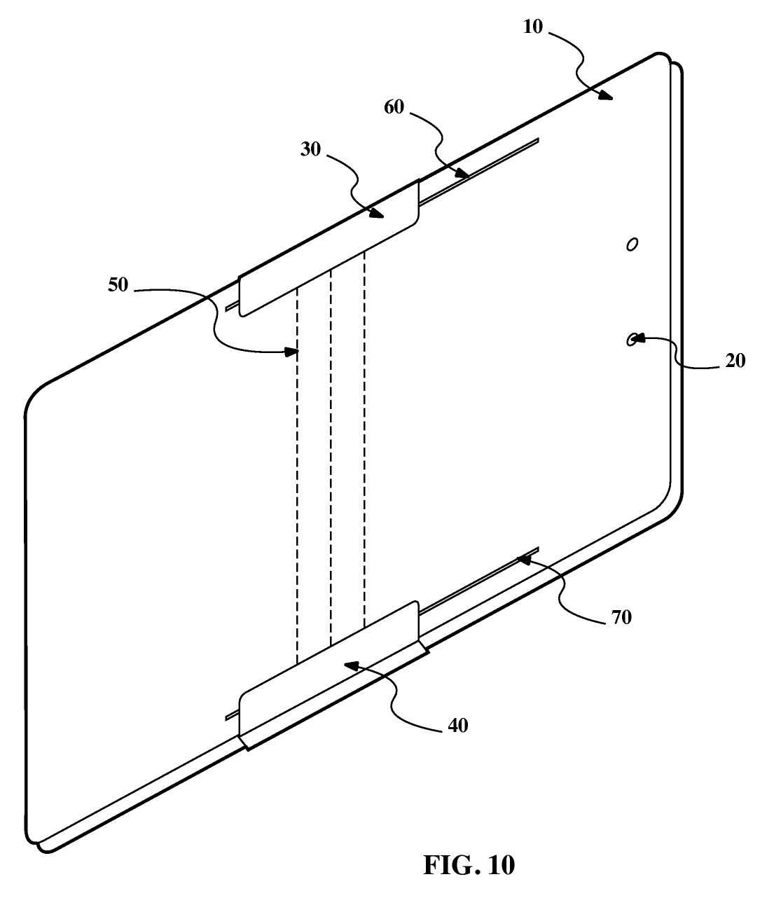

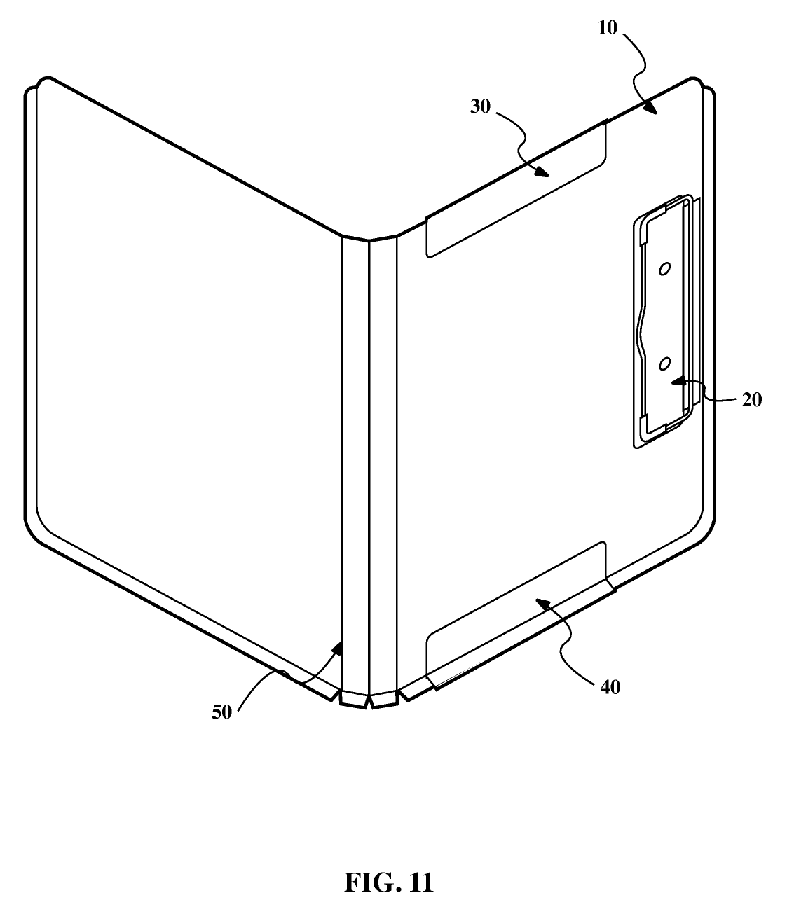

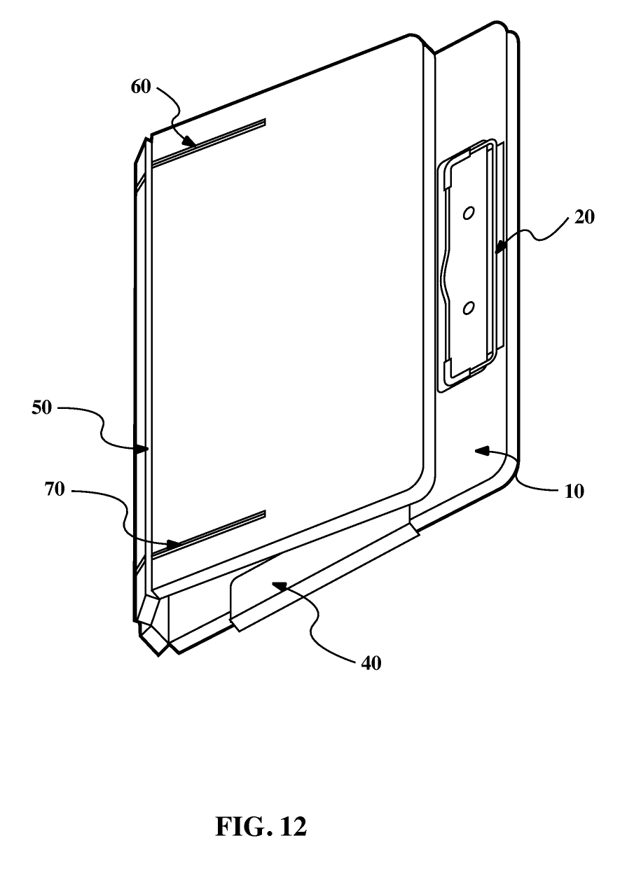

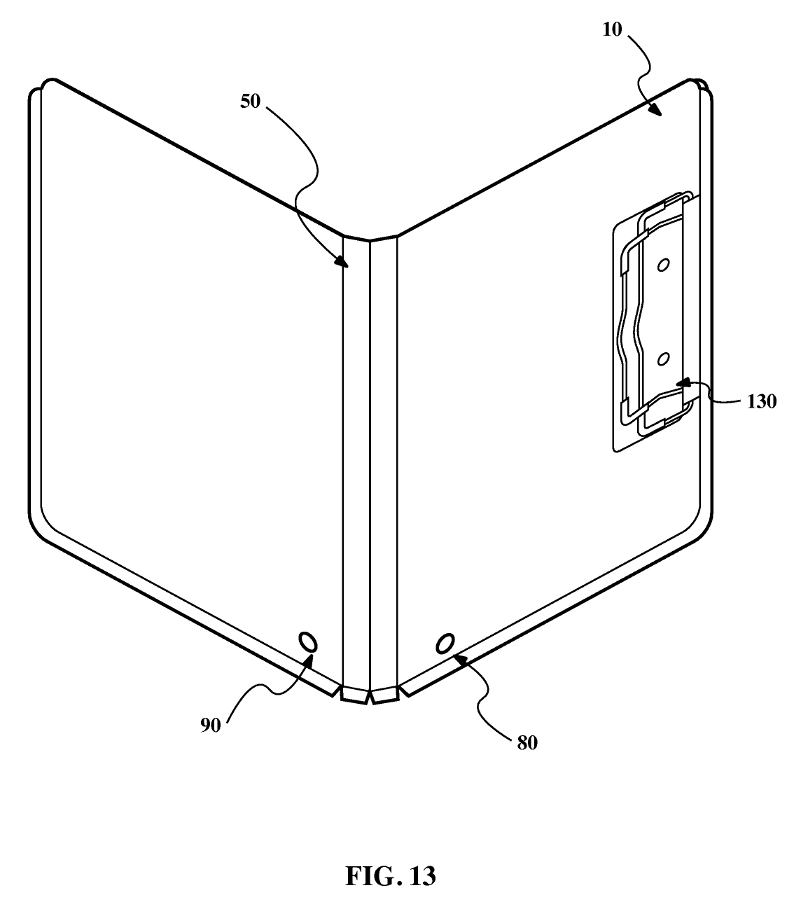

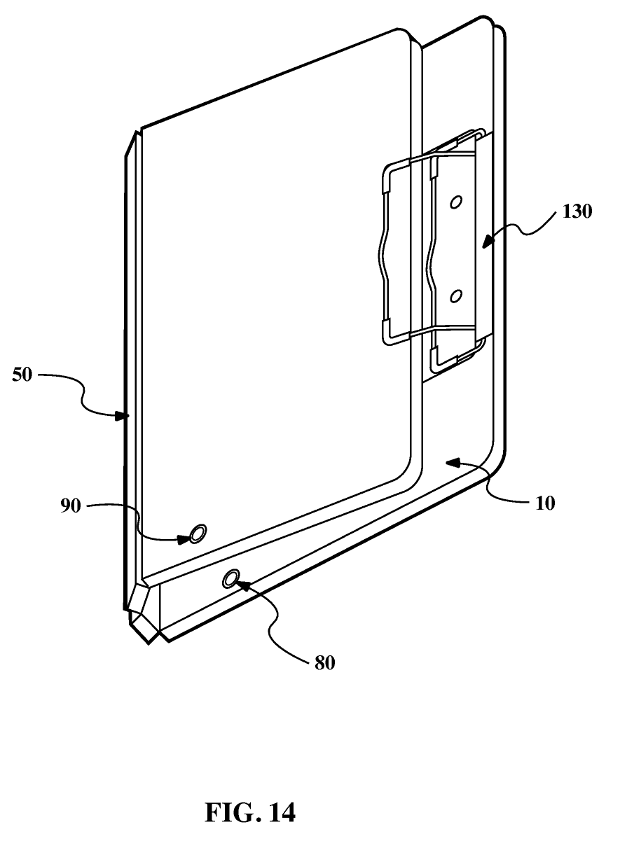

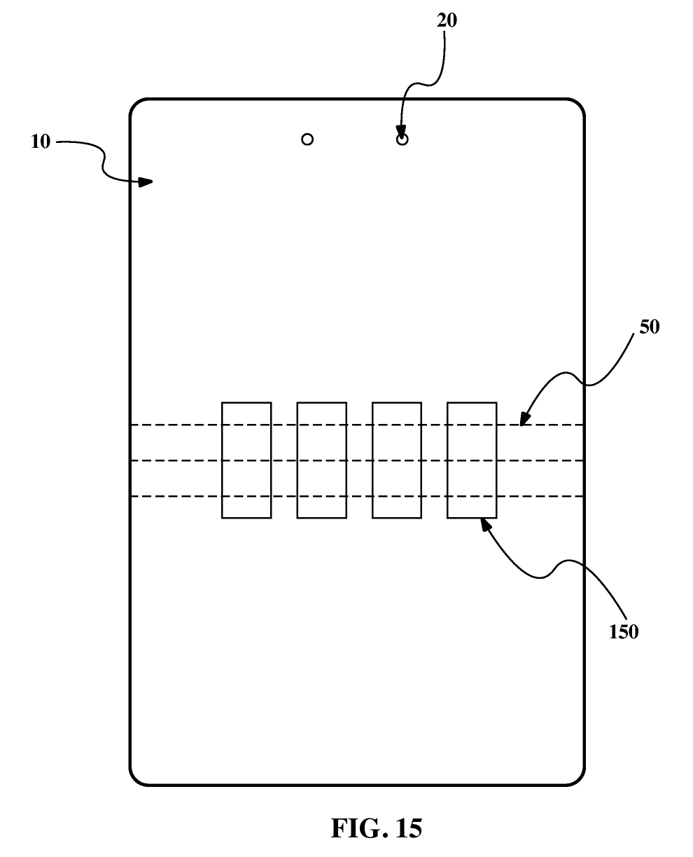

FIG. 8 and FIG. 10 show the rear elevational view and rear perspective view of the foldable clipboard 10 with at least one pair of slidable brackets 30 and 40 and a pair of sliding grooves 60 and 70 respectively. The pair of sliding grooves 60 and 70 includes a right locking bracket sliding groove 60 and a left locking bracket sliding groove 70. FIG. 11 illustrates the foldable clipboard 10 in a partially folded state with at least one pair of slidable locking brackets 30 and 40 in the unlocked position and FIG. 12 illustrates the foldable clipboard 10 in the folded position. The foldable clipboard 10 is inexpensive to manufacture and can be made of light weight material for the ease of carrying. FIG. 13 illustrates the foldable clipboard 10 containing an alternative secondary locking latch 130 which does not affect the latch 20 which holds the items intact. The alternative secondary locking latch 130 is used to keep the foldable clipboard in a folded or closed position as shown in FIG. 14. As seen in FIG. 15, in one present embodiment of the present invention, the locking means consists of adjustable magnets 150 that act to prevent unwanted movement when the clipboard is in an open position and ensures a flat writing surface is maintained. It is to be noted that the magnets 150 may consist of individual magnet pieces or one large magnet piece.

Thus, specific embodiments and applications of the foldable clipboard have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

1. A foldable clipboard comprising:
a flat board with an upper end and a lower end, having a writing surface and a rear surface;
an engagement connector that pivotably couples the upper end to the lower end;
an attachment device proximate the upper end of the writing surface; and
whereby the engagement connector pivotably collapses the upper end towards the lower end of the flat board facilitating portability.

2. The foldable clipboard device as recited in claim 1, wherein the attachment device is a clip for holding at least one item.

3. The foldable clipboard device as recited in claim 1, wherein the engagement connector is a plurality of folding serrations.

4. The foldable clipboard device as recited in claim 3, wherein the plurality of folding serrations engage together to fold the clipboard forming a continuous and seamless surface.

5. The foldable clipboard device as recited in claim 3, wherein the plurality of folding serrations prevent the creasing of a paper carried on said clipboard in a closed position.

6. The foldable clipboard device as recited in claim 1, containing a locking means to keep said foldable clipboard in an open position.

7. The locking means as recited in claim 6, wherein said locking means includes magnets.

8. The locking means as recited in claim 6, wherein said locking means includes a plurality of rivets, wherein the plurality of rivets include a latch pivot rivet and latch receiver rivet and one end of the latch is fixed to a latch pivot rivet and another end is selectively adapted to receive a latch receiver rivet.

9. The locking means as recited in claim 6, wherein said locking means includes at least one slidable bracket slidably attached to an edge of the clipboard to prevent unwanted folding of the flat board.

10. The locking means as recited in claim 9, wherein the at least one slidable bracket is a left locking bracket, and said foldable clipboard further comprises a right locking bracket.

11. The locking means as recited in claim 9 further including a right locking bracket sliding groove and a left locking bracket sliding groove.

12. The foldable clipboard device as recited in claim 1, wherein the flat board may be arranged in a folded state thereby protecting the item by way of an extra cover.

13. The foldable clipboard device as recited in claim 1, wherein the plurality of folding serrations are disengaged in an open position for providing a flat writing surface.

14. The foldable clipboard device as recited in claim 1 further comprising a secondary latch which urges the flat board to remain in a folded position.

15. A foldable clipboard comprising:
a flatboard having an upper end and a lower end;
a clipping means disposed on the upper end for securing papers; and
wherein said upper end pivotably moves in relation to said lower end between an open position and a closed position

16. The foldable clipboard as recited in claim 15 further comprising a means for locking said upper end and lower end in said open position.

17. The foldable clipboard as recited in claim 16, wherein the upper end and the lower end together forms a flat writing surface in the open position.

18. The foldable clipboard as recited in claim 17, wherein in a closed position, a clearance exists between the upper end and the lower end.

19. The folded clipboard as recited in claim 15, comprising of a coupling means wherein in the closed position, said lower end is coupled to said upper end.
